(19) United States
(12) Patent Application Publication
(10) Pub. No.: US 2024/0356279 A1
(43) Pub. Date: Oct. 24, 2024

(54) HOUSING ASSEMBLY, PLUG CONNECTOR AND CONNECTION DEVICE

(71) Applicant: TE Connectivity Solutions GmbH, Schaffhausen (CH)

(72) Inventors: Hartmut RIPPER, Bensheim (DE); Joe-Anne LINGOS, Bensheim (DE); Benjamin BECKER, Bensheim (DE); Gabriel HOTEA, Bensheim (DE); Markus KRESSMANN, Bensheim (DE)

(21) Appl. No.: 18/637,846

(22) Filed: Apr. 17, 2024

(30) Foreign Application Priority Data
Apr. 19, 2023 (DE) 102023109888.8

(51) Int. Cl. H01R 13/627

(52) U.S. Cl. CPC H01R 13/6271

(57) ABSTRACT

A housing assembly for a plug connector includes a contact housing and a securing element, wherein the contact housing includes a contact chamber for receiving a contact unit of the plug connector, a latching element movable between a latching position and a release position, which, in the latching position, protrudes at least sectionally into the contact chamber, and a securing receptacle leading at least sectionally into the contact chamber, which is configured to receive the securing element at least partly, wherein the securing element includes a chock section and a lock section, wherein, when the securing element is completely received in the securing receptacle, a movement of the latching element from the latching position in a direction away from the contact chamber is blocked by the chock section and the lock section protrudes at least partly from the securing receptacle into the contact chamber.

### CROSS REFERENCE TO RELATED APPLICATIONS

This application claims the benefit of DE Application No. 102023109888.8, filed 19 Apr. 2023, the subject matter of which is herein incorporated by reference in its entirety.

### BACKGROUND OF THE INVENTION

The subject matter herein relates to a housing assembly for a plug connector of a high-frequency, signal and/or data line.

Many areas of technology use connection devices with connector housings in which contact units are positioned in a latching manner. The contact units can be individual contact elements (for example so-called crimp terminals) or contact holders with several contact elements.

It is not only in the case of heavily loaded connection devices that the contact units can become loose or come into an incorrect position during installation or operation. This can then lead to transmission problems or even to a complete failure of the corresponding line.

There is a need for reliable connection devices that are less prone to incorrect positioning.

### BRIEF DESCRIPTION OF THE INVENTION

In one embodiment, a housing assembly for a plug connector is provided including a contact housing and a securing element, wherein the contact housing comprises at least one contact chamber for receiving a contact unit of the plug connector, a latching element movable between a latching position and a release position, which, in the latching position, protrudes at least sectionally into the at least one contact chamber, and a securing receptacle leading at least sectionally into the at least one contact chamber, which is configured to receive the securing element at least partly, wherein the securing element comprises at least one chock section and at least one lock section, wherein, when the securing element is completely received in the securing receptacle, a movement of the at least one latching element from the latching position in a direction away from the at least one contact chamber is blocked by the at least one chock section and the at least one lock section protrudes at least partly from the securing receptacle into the at least one contact chamber. The securing element allows for a twofold securing of one and the same contact unit. Further, a plug connector as well as a connection device are provided including such housing assembly.

For the sake of better readability of the description, only the singular is used for some features of the housing assembly, although these features may also be provided in the plural. For example, the contact housing comprises at least one contact chamber and at least one latching element. Accordingly, the securing element comprises at least one chock section and at least one lock section.

An advantage of the subject matter herein results from the fact that the securing element can fulfill both a primary securing function and a secondary securing function for the contact unit to be received, if the securing element is completely received in the securing receptacle.

The primary securing function results from the fact that the chock section of the securing element blocks the movement of the latching element. In particular, the latching element, which is used for latching with the contact unit to be received, cannot move out of the latching position and the contact unit to be received remains latched in the contact chamber. In other words, the chock section is suitable for securing the latching connection and thus indirectly the contact unit.

The secondary securing function results from the fact that the lock section protrudes or projects into the contact chamber and can engage in a form-fit connection with the contact unit to be received there. Thus, the lock section is suitable for directly securing the contact unit.

The securing element completely received in the securing receptacle is in a securing position. In other words, the securing element is in the securing position when the securing element is completely located in the securing receptacle. In this case, completeness only results from the fact that both, the chock section and the lock section, are positioned in the securing position at the respective destination in the contact housing just described. Other sections or parts of the securing element can also protrude from the contact housing in the securing position as required.

Overall, the securing element provides double securing for one and the same contact unit. This is particularly preferred if the latching element must have a certain flexibility for the purpose of latching, which inevitably involves compromising the flexural rigidity of the latching element. The securing element can contribute its flexural rigidity.

The contact housing and the securing element can also each be regarded as independent and are not necessarily part of the housing assembly, but may be provided separately and independently of each other.

The subject matter herein can be further improved with the following embodiments, each of which is preferred individually and can be combined with one another as desired.

According to one possible embodiment, the contact housing and/or the securing element can be made of an electrically insulating material in order to avoid short circuits and increase electrical safety. For example, the contact housing and/or the securing element can be an injection-molded part made of plastic.

The contact chamber preferably leads through the contact housing so that the contact chamber is accessible from one side for a mating contact and a wire or cable can lead to the contact unit on an opposite side. The securing receptacle leading into the contact chamber thereby leads into or communicates with the contact chamber.

According to a further possible embodiment, the chock section and the lock section can be located opposite of each other with respect to the contact chamber when the securing element is completely received in the securing receptacle. For this purpose, the chock section and the lock section are preferably spaced apart from each other. This leads to an increased stability due to the resulting two-sided securing of the contact unit. In other words, with this embodiment, the contact unit can be secured from two opposite sides by the securing element.

Furthermore, the chock section and the lock section can extend at least partly parallel to each other, resulting in an extremely simple structure of the securing element. Alternatively, the chock section and lock section can also converge at an angle. In particular, the chock section and lock section can run perpendicular to each other.

According to a further possible embodiment, the latching element moved out of the latching position can form a stop for the chock section of the securing element. In particular, the stop can be located in a region or an area of the securing receptacle in which the chock section is located when the securing element is completely received in the securing receptacle. Optionally, the above region of the securing receptacle is swept over by the stop when the latching element is moved from the latching position into the release position.

The advantage of this embodiment arises when installing the housing assembly in a plug connector. Thus, during installation, it may be intended to first insert the contact unit into the contact chamber (in the absence of the securing element). Normally, the contact unit and the latching element enter into the above latching connection, wherein the latching element changes between its release position and its latching position at least once. The securing element is then inserted into the securing receptacle.

As long as the latching element is still in its release position or at least not in its latching position, the stop blocks the securing receptacle due to its positioning in the securing receptacle. Consequently, the securing element cannot be completely inserted into the securing receptacle in this state because it collides with the stop. At the same time, this state indicates that the latching element is not in the above latching connection with the inserted contact unit, as the latching element is obviously not in its latching position.

In other words, the latching element cannot move into the latching position and remains in the release position or at least outside the latching position if the contact unit is not “seated” correctly in the contact chamber. Consequently, the stop on the latching element then prevents the securing element from being inserted into the securing receptacle, which is noticed by the assembling personnel and taken as an opportunity to check the contact unit for positioning errors. The securing element thus fulfills a so-called TPA function (Terminal Position Assurance) in addition to the actual securing function and serves as an indicator for incorrectly positioned contact units.

The latching element can be movable under temporary or permanent elastic deformation, pivoting or bending. For example, the latching element can comprise a cantilevered latching arm or a latching lance according to an easily producible embodiment. The latching arm is preferably based in the contact housing and is monolithically connected to the rest of the contact housing. Furthermore, the latching arm can extend at least sectionally between the contact chamber and the securing receptacle.

To ensure that the latching element is not permanently loaded in the latching position, the chock section can abut against the latching element in a force-free manner. This means that the chock section preferably does not press on the latching element, however it restricts its mobility.

Alternatively, the latching element can comprise a separate slider or tilting mechanism, which is held movably in the contact housing, instead of the monolithic latching arm. Optionally, the slider or tilting mechanism is preloaded with a tension spring in the direction of the latching position.

According to another possible embodiment, the securing receptacle can extend at least sectionally transversely, in particular perpendicular to the contact chamber. Furthermore, the securing receptacle can be open on one side from a securing insertion direction. In this case, the securing insertion direction extends correspondingly transversely, in particular perpendicular to a contact insertion direction in which the contact unit is inserted into the contact chamber. This embodiment is preferred as it allows the securing element to be inserted into the contact housing even when the plug connector is plugged together.

In order to achieve the aforementioned two-sided securing of the contact unit as easily as possible, it is advisable for the securing receptacle to surround the contact chamber from at least three adjacent sides that are perpendicular to each other in pairs. If the contact housing has several contact chambers, each contact chamber can be surrounded by the securing receptacle from three sides perpendicular to each other in pairs. Consequently, the securing element in the securing receptacle surrounds the contact chambers and the contact units received therein from a correspondingly large number of sides. Depending on the number of contact chambers, the securing element can have a U-profile, a double U-profile or a multiple U-profile.

The securing element can, of course, also surround the contact units received from several sides that are not perpendicular to each other, as long as the enclosing angle of the securing element with respect to the respective contact unit is at least 180°. In other words, the securing element encloses at least 50% of the circumference of the contact units received in the contact chambers. The securing element can then have a round profile or polygonal profile, for example.

In embodiments in which the chock section and lock section converge at an angle, in particular perpendicular to each other, it is also sufficient for the securing receptacle to surround the contact chamber from two sides. Consequently, the securing element in the securing receptacle surrounds the contact chambers and the contact units received therein from a corresponding number of sides. The securing element can thereby have an L-profile, V-profile or, in the case of several contact chambers, a W-profile.

For better attachment to the contact housing after it has been received in the securing receptacle, the securing element can comprise an attachment section with which the securing element can be attached to the contact housing. For example, the securing element can have one or more latching lugs that latch with a corresponding number of latching recesses or latching edges within the securing receptacle. The latching action advantageously allows an acoustic assembly check.

As already indicated above, the contact housing can have several contact chambers, for example two that run parallel to each other at least sectionally. This allows the range of applications of the housing assembly to be extended to plug connectors with two contact units.

The securing receptacle and/or the latching element can extend at least sectionally between the two contact chambers. Accordingly, the securing element in the securing receptacle can secure two contact units simultaneously. For this purpose, the chock section and/or the lock section can also extend at least sectionally between the two contact chambers when the securing element is completely received in the securing receptacle. This space-saving position of the chock section and/or lock section results in a compact housing assembly.

Optionally, the contact housing can comprise two latching elements that are configured to move towards or away from each other in their respective latching position or their respective release position. In an alternative embodiment of the two latching elements, the directions of movement between the respective release position and latching position can run parallel to each other.

Depending on the specific application, more than two, in particular an even number of contact units can be installed in the plug connector. For this purpose, the contact housing can have two rows of contact chambers. In particular, a separate latching element can be provided for each contact chamber. This makes it possible to install the contact units individually and independently of each other in the respective contact chambers. Furthermore, the latching elements can be aligned in pairs perpendicular to the securing insertion direction. Instead of being aligned in pairs, the latching elements can also be offset from each other in the securing insertion direction. This has the advantage that in the event of a collision between the securing element and the stop, a clear assignment between the insertion depth of the securing element and the latching element causing the collision is possible. This clear assignment is particularly important for fully automated assembly processes.

The problem introductorily set out can also be solved by a plug connector with a housing assembly according to one of the above embodiments and a contact unit for contacting mating contacts of a mating plug, wherein the contact unit is received in the contact chamber of the contact housing and is in a latching connection with the latching element, and wherein the securing element is completely received in the securing receptacle, secures the latching connection with the chock section and is in a form-fit connection with the contact unit via the lock section.

For the sake of better readability of the description, only the singular is used for some features of the plug connector, although these features may also be provided in the plural. For example, the plug connector has at least one contact unit. Accordingly, in each case one contact unit can be received in one contact chamber of the contact housing.

The plug connector benefits from the advantages of the housing assembly that have already been explained. In particular, the primary and secondary locking function doubly ensures that no positioning errors can occur due to displacement of the contact unit.

According to one possible embodiment of the plug connector, the lock section can abut against the contact housing on a side facing away from the form-fit connection, i.e. on the reverse side of the form-fit connection. This increases the flexural rigidity of the lock section, which prevents the lock section from being pushed away when a cable or wire leading to the contact unit is subjected to a tensile load.

According to a further possible embodiment of the plug connector, the securing element can comprise at least one support section that abuts against the contact unit. Preferably, the at least one support section abuts the contact unit in a force-free manner. Furthermore, the at least one support section can be spaced apart from the latching element and the lock section in the extension direction of the contact chamber. This results in a three-point support, which limits the wobble of the contact unit and, for example, makes it easier to plug the contact unit into the mating plug's mating contacts by preventing the contact unit from tilting.

Optionally, the plug connector can be configured as a module that can be attached to a main connector together with other modules. This makes the plug connector suitable for retrofitting, expanding or upgrading the main connector.

A connection device with the above plug connector and with a mating plug configured complementarily to the plug connector also solves the problem introductorily set out, wherein the plug connector and mating plug are configured so that they can be plugged together, and wherein the mating plug is also configured in accordance with one of the above embodiments of the plug connector. The mating plug can comprise a connector housing configured complementarily to the contact housing of the plug connector. The mating contact of the mating plug can be received in a latching manner in the connector housing, wherein the mating contact is configured complementarily to the contact unit and so that it can be plugged together with the contact unit. Optionally, the mating plug can comprise a securing element configured analogously to the securing element of the plug connector.

For the sake of better readability of the description, only the singular is mentioned for some features of the connection device, although these features may also be provided in the plural. For example, the connection device has at least one mating contact.

The connection device benefits from the advantages of the housing assembly and the plug connector, which have already been explained. In particular, it is preferred that the connection device makes use of the primary and secondary securing function of the respective securing element in both the plug connector and the mating plug.

In the following, the invention is explained in more detail with reference to the drawings by means of several exemplary embodiments, the different features of which can be combined with one another as desired in accordance with the above comments. In particular, according to the above explanations, individual features can be added to the embodiments described if the effect of these features is necessary for a particular application. Conversely, individual features can be omitted from the embodiments described if the technical effect of these features is not important in a specific application. In the drawings, similar, identical and functionally identical elements are provided with identical reference signs, insofar as this is useful.

### BRIEF DESCRIPTION OF THE DRAWINGS

FIG. 1 a schematic perspective view of a housing assembly according to a first exemplary embodiment as an exploded view;

FIG. 2 a schematic sectional view of the housing assembly from FIG. 1;

FIG. 3 a further schematic sectional view through the housing assembly from FIG. 1;

FIG. 4 a schematic sectional view of a plug connector according to an exemplary embodiment;

FIG. 5 another schematic sectional view of the plug connector from FIG. 4;

FIG. 6 a schematic perspective view of a connection assembly according to an exemplary embodiment as an exploded view; and

FIG. 7 another schematic perspective view of the connection assembly from FIG. 6.

### DETAILED DESCRIPTION OF THE INVENTION

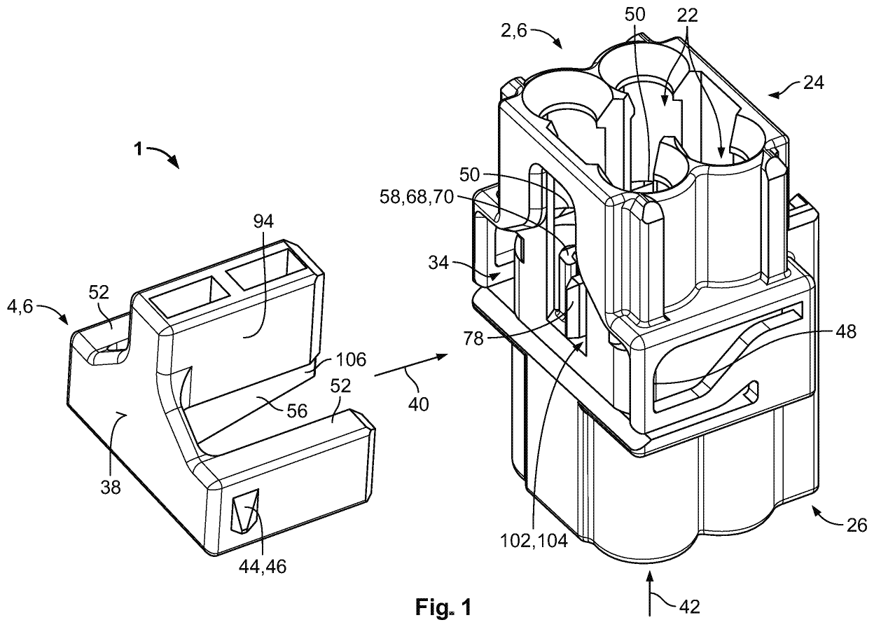

FIGS. 1 to 3 show a housing assembly 1 in perspective view and in various views with different sectional planes. The housing assembly 1 comprises a contact housing 2 and a securing element 4. Both the contact housing 2 and the securing element 4 can be made of an electrically insulating material, for example as injection-molded plastic parts 6.

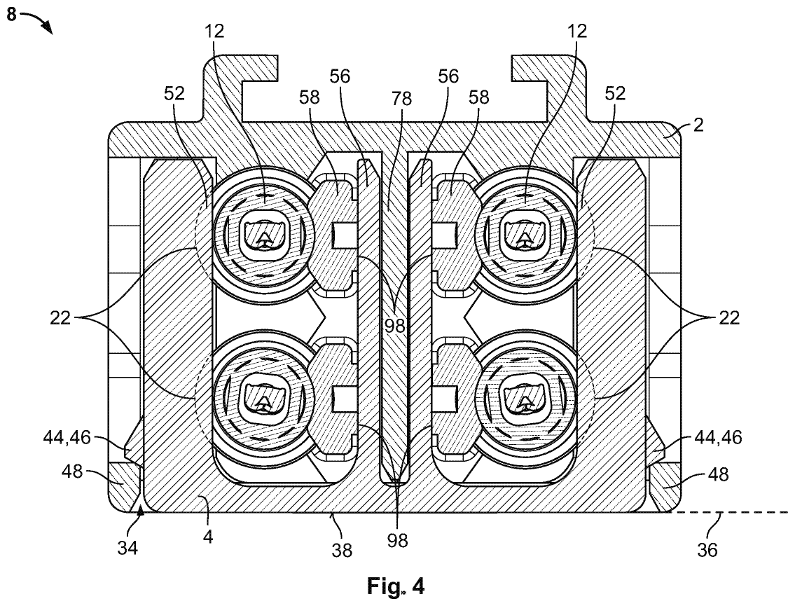

The housing assembly 1 can be used in an electrical plug connector 8, as shown in FIGS. 4 to 7. The plug connector can be used in a high-frequency, signal and/or data line 10.

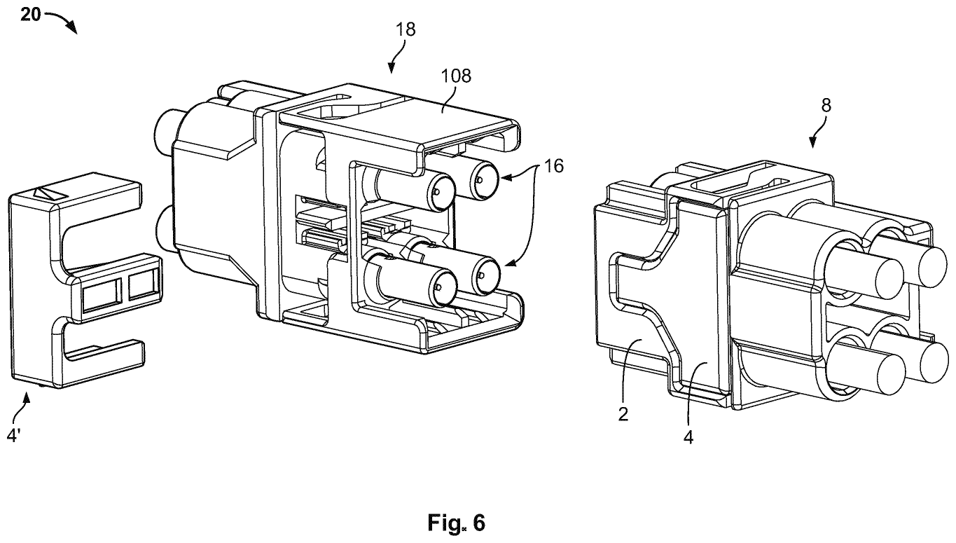

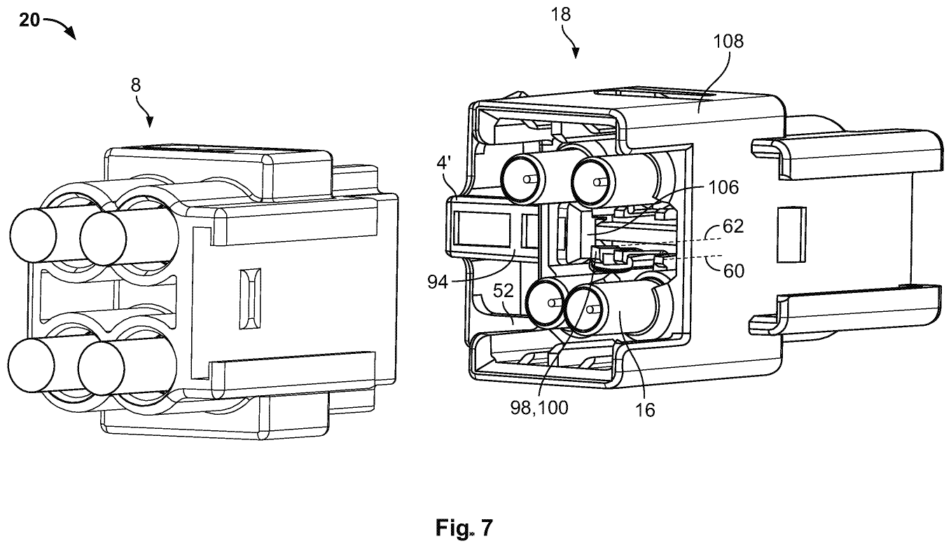

In addition to the housing assembly 1, the plug connector 8 comprises at least one contact unit 12. In the embodiments shown, the plug connector 8 comprises four contact units 12. The contact units may be individual, shielded or unshielded contact elements 14 (for example, so-called crimp terminals). Alternatively, the contact units 12 can each comprise a contact holder (not shown) with several of such contact elements. The contact units 12 serve to contact in each case one mating contact 16 of a mating plug 18 of an electrical connection device 20. The connection device 20 is shown in FIGS. 6 and 7.

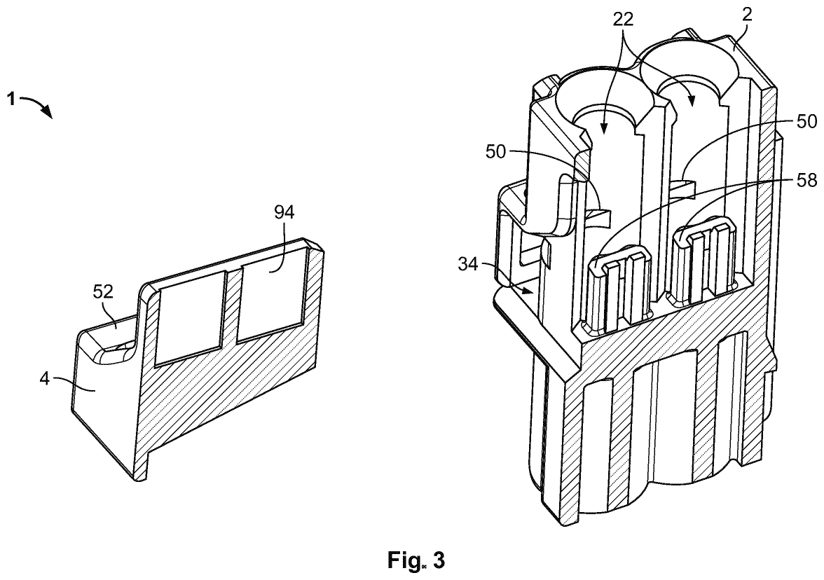

It can be seen from FIG. 3 that the contact housing 2 in each case comprises a contact chamber 22 for receiving a respective contact unit 12 of the plug connector 8. The respective contact chambers 22 preferably lead through the contact housing 2, so that each contact chamber 22 is accessible from one side 24 for the associated mating contact 16 and a wire 28 or cable 30 can lead to the contact unit 12 on an opposite side 26. According to the embodiment shown, the contact housing 2 can thus have four contact chambers 22 for the four contact units 12, which run parallel to one another at least sectionally. The contact chambers 22 can be arranged in two rows 32 in the contact housing 2.

In FIG. 1, it can be seen that the contact housing 2 comprises a securing receptacle 34, which is configured to at least partly receive the securing element 4. The securing element 4, which is completely received in the securing receptacle 34, is in a securing position 36 (see FIG. 4). In other words, the securing element 4 is in the securing position 36 when the securing element 4 is completely located in the securing receptacle 34. The completeness only results from the fact that the securing element 4 is properly positioned in the contact housing 2 in the securing position 36. Sections or parts of the securing element 4 can nevertheless also protrude from the contact housing 2 in the securing position 36. For example, a gripping surface 38 or a handle (not shown) of the securing element 4 can protrude from the contact housing 2 and not be received in the securing receptacle 34, even if the securing element 4 is in the securing position 36.

The securing receptacle 34 can extend at least sectionally transversely, in particular perpendicularly to the contact chambers 22. Furthermore, the securing receptacle 34 can be open on one side from a securing insertion direction 40. The securing insertion direction 40 thereby extends accordingly transversely, in particular perpendicularly to a contact insertion direction 42, in which the contact units 12 are inserted into the respective contact chambers 22.

For better attachment to the contact housing 2 after it has been received in the securing receptacle 34, the securing element 4 can comprise an attachment section 44 with which the securing element 4 can be attached to the contact housing 2. For example, the securing element 4 can comprise one or more latching lugs 46, which latch with a corresponding number of latching edges 48 within the securing receptacle 34 (see FIG. 4).

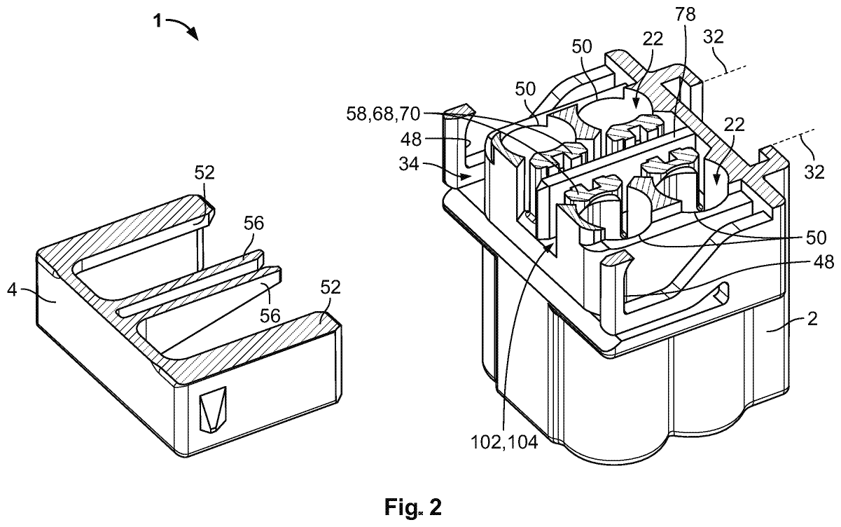

It can be seen from FIG. 2 that the securing receptacle 34 extends at least sectionally between the rows 32 of contact chambers 22. Furthermore, the securing receptacle 34 opens into the respective contact chambers 22. In other words, the securing receptacle 34 leads into the respective contact chambers 22 or communicates with them. For this purpose, the contact housing 2 can each have an access slot 50, which connects the respective contact chamber 22 with the securing receptacle 34. The access slots 50 can be located between the rows 32 of contact chambers 22. Alternatively, the rows 32 of contact chambers 22 can also run between the access slots 50 (see FIG. 2).

The securing element 4 comprises at least one lock section 52. As shown in FIG. 2, the securing element 4 preferably has a lock section 52 for each row 32 of contact chambers 22. When the securing element 4 is completely received in the securing receptacle 34 (i.e. in the securing position 36), the lock sections 52 protrude from the securing receptacle 34 at least partly into the contact chambers 22 of the associated row 32 of contact chambers 22. In other words, the lock sections 52 extend through the respective access slots 50 and protrude into the associated contact chambers 22. As will be explained in more detail below, the lock sections 52 are configured to form a form-fit connection 54 with each of the contact units 12 in the contact chambers 22.

The securing element 4 also comprises at least one chock section 56. As shown in FIG. 2, the securing element 4 preferably comprises a chock section 56 for each row 32 of contact chambers 22. The chock sections 56 and lock sections 52 are preferably spaced apart from each other in pairs. Furthermore, the chock sections 56 and the lock sections 52 can extend at least partly parallel to each other. In the securing position 36 of the securing element 4, the chock sections 56 and the lock sections 52 can lie opposite each other in pairs with respect to the rows 32 of contact chambers 22 (see FIG. 4).

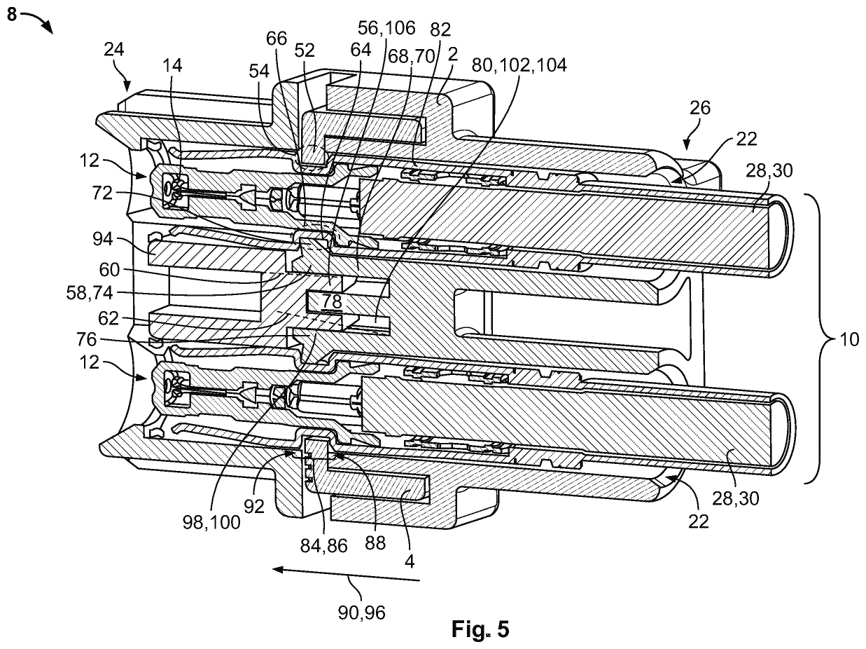

The chock sections 56 serve to secure latching elements 58 of the contact housing 2, as is explained in more detail below. Preferably, a separate latching element 58 is provided on or in the contact housing 2 for each contact chamber 22. The latching elements 58 are movable between a latching position 60 (see FIG. 5) and a release position 62 (see FIG. 7). In the latching position 60, each latching element 58 protrudes into one of the contact chambers 22. There, the latching element 58 can engage in a latching recess 64 of the respective contact unit 12 (see FIG. 5). Thus, each latching element 58 is configured to enter into a latching connection 66 with the contact unit 12, which is located in the corresponding contact chamber 22, in the latching position 60.

In pairs, the latching elements 58 are configured to move towards or away from each other or parallel to each other in their respective latching position 60 or their respective release position 62.

Each latching element 58 may be movable under temporary or continuous elastic deformation, pivoting or bending. For example, each latching element 58 can comprise a cantilevered latching arm 68 or a latching lance 70. The latching arm 68 can in turn be formed in one piece with the contact housing 2. Preferably, the latching arm 68 is based in the contact housing 2 and is monolithically connected to the rest of the contact housing 2. Furthermore, the latching arm 68 can extend at least sectionally between the contact chamber 22 and the securing receptacle 34.

Each latching element 58 can comprise a latching section 72 that protrudes from the latching arm 68 and extends into the associated contact chamber 22. Latching arm 68 and latching section 72 can together form a latching hook 74.

In the release position 62, the respective latching element 58, in particular its latching section 72, leaves the contact chamber 22. This means that without the securing element 4 in the securing position 36, the latching element 58 can be moved into the release position 62 and consequently the contact unit 12 can be installed in the contact chamber 22. Potentially, the contact unit 12 can also leave the contact chamber 22 again (intentionally or unintentionally), provided that the latching element 58 is moved into the release position 62 for this purpose.

In order to simplify an intended movement of the latching element 58 into the release position 62 during a repair, the latching element 58 can comprise an engagement section 76 (see FIG. 5) to which a tool tip (not shown), for example the tip of a screwdriver, can be engaged. To prevent overstretching, buckling or breaking off of the latching arm 68, the contact housing 2 may have a support rib 78 which extends between the rows 32 of contact chambers 22, is spaced apart from the latching elements 58, and against which the latching elements 58 abut before they would be subject to plastic deformation.

When installing the contact units 12 in the contact housing 2, it may be intended to first insert the respective contact units 12 into the associated contact chamber 22 (in the absence of the securing element). Normally, the contact unit 12 and the latching element 58 enter into the above latching connection 66, wherein the latching element 58 changes between its release position 62 and its latching position 60 at least once. The securing element 4 is then inserted into the securing receptacle 34.

When the securing element 4 is completely received in the securing receptacle 34, movement of the latching element 58 in the direction away from the contact chamber 22 is blocked, hindered or prevented by the associated chock section 56 (see FIG. 5). For example, the chock sections 56 of the securing element 4 can be pushed into the spaces 80 between the latching elements 58 and the support rib 78 and there prevent or oppose the movement of the latching element 58 from the latching position 60 into the release position 62.

In order not to have the latching elements 58 permanently loaded in the latching position 60, the chock sections 56 can abut the latching elements 58 in a force-free manner. This means that the chock sections 56 preferably do not press on the latching elements 58, yet restrict their mobility to such an extent that the aforementioned latching connection 66 remains in place. In this state, the contact units 12 cannot be removed (at least not non-destructively) from the contact chambers 22.

The contact units 12 can, for example, each comprise a cylindrical shielding 82 which surrounds the aforementioned contact element 14. On an outer surface of the contact unit 12, in particular an outer surface of the shielding 82, a circumferential shoulder 84 or groove 86 can form the already above-mentioned latching recess 64, into which the latching element 58 engages. In other words, the contact unit 12, in particular the shielding 82, can have a taper 88 in the axial direction 90 followed by a widening 92. The latching element 58, in particular its latching section 72, engages between the taper 88 and the widening 92 for the purpose of the latching connection 66. In addition, a lock section 52 engages between the taper 88 and the widening 92 in order to create the aforementioned form-fit connection 54.

Accordingly, in the plug connector 8, the contact units 12 received in the contact chambers 22 of the contact housing 2 are in the latching connection 66 with the associated latching elements 58 and in the form-fit connection 54 with the associated lock sections 52. Here, the respective latching connection 66 is secured by the associated chock sections 56.

As can be seen in FIG. 5, the latching connection 66 and the form-fit connection 54 can be positioned opposite each other in relation to the respective contact unit 12. This means that the contact units 12 can also be secured on both sides by the securing element 4.

As is also clear from FIG. 5, the lock sections 52 can abut the contact housing 2 on a side facing away from the form-fit connection 54, i.e. on the reverse side of the form-fit connection 54. This increases the flexural rigidity of the respective lock section 52, which prevents the lock section 52 from being pushed away when the cable 30 or wire 28 leading to the contact unit 12 is subjected to a tensile load.

Furthermore, FIG. 5 shows that the securing element 4 can comprise a support section 94 that abuts against the contact units 12. Preferably, the support section 94 abuts the contact units 12 in a force-free manner. Furthermore, the support section 94 can be spaced apart from the latching elements 58 and the lock sections 52 in the extension direction 96 of the contact chambers 22. This results in a three-point support, which limits the wobble of the contact units 12.

In order to detect positioning errors of the contact units 12, the contact housing 2 can comprise a blocking section 98 for each latching element 58, the function of which is explained below.

Each latching element 58 moved out of the latching position 60 can form a stop 100 for the chock section 56 of the securing element 4. In particular, the stop 100 may be located in an area 102 of the securing receptacle 34 in which the chock section 56 would be located when the securing element 4 is completely received in the securing receptacle 34. Optionally, said area 102 of the securing receptacle 34 is swept over by the stop 100 during the movement of the respective latching element 58 from the latching position 60 to the release position 62.

The stop 100 can be formed in particular by the blocking section 98. For this purpose, the blocking section 98 protrudes into the securing receptacle 34 when the latching element 58 is in the release position 62. For this purpose, the securing receptacle 34 can form an evasive recess 104, which is configured to at least partly receive the blocking section 98 in the absence of the securing element 4 when the at least one latching element 58 is in its release position 62.

Each blocking section 98 is connected to the associated latching section 72 in a motion-transmitting manner. To simplify the housing structure, the latching section 72 and the blocking section 98 can be connected in one piece. For example, the blocking section 98 is also formed on the aforementioned latching arm 68. Preferably, latching section 72 and blocking section 98 are located on opposite sides with respect to latching arm 68. The latching section 72 can here be directed towards the contact chamber 22 and the blocking section 98 towards the evasive recess 104. This results in a simple movement sequence, since the latching arm 68 can be pivoted from the contact chamber 22 into the evasive recess 104 and vice versa.

As long as the latching element 58 is still in its release position 62 or at least not in its latching position 60, the stop 100 blocks the securing receptacle 34 by its positioning in the evasive recess 104. Consequently, the securing element 4 cannot be completely inserted into the securing receptacle 34 in this state because it collides with the stop 100. At the same time, this state indicates that at least one latching element 58 is not in said latching connection 66 with the inserted contact unit 12, as the latching element 58 is obviously not in its latching position 60.

In other words, the latching element 58 cannot move into the latching position 60 and remains in the release position 62 or at least outside the latching position 60 if the contact unit 12 is not properly “seated” in the contact chamber 22. Consequently, the stop 100 on the latching element 58 then obstructs the insertion of the securing element 4 into the securing receptacle 34. This state is indicated in FIG. 7 for the lower left contact unit 12. The securing element 4 thus fulfills a so-called TPA function (Terminal Position Assurance) in addition to the actual securing function and serves as an indicator for incorrectly positioned contact units 12.

This TPA function can be well fulfilled if the securing element 4 has a detecting section 106, which preferably protrudes from the rest of the securing element 4 in the securing insertion direction 40. The securing element 4 can then be inserted with the detecting section 106 first into the securing receptacle 34, wherein the detecting section 106 strikes against the blocking section 98, provided that the latter blocks the securing receptacle, in particular the evasive recess 104. Detecting section 106 and lock section 52 or detecting section 106 and chock section 56 can coincide, match or correspond.

Accordingly, a separate evasive recess 104 may be provided for each latching element. In turn, a separate blocking section 98 and/or a separate detecting section 106 may be provided for each evasive recess 104. Alternatively, a common evasive recess 104 may be provided for all latching elements 58. In this case, a common blocking section 98 and/or a common detection section 106 is sufficient.

As can be seen from FIG. 4, the securing receptacle 34 can surround the contact chambers 22 from at least three adjacent sides perpendicular to each other in pairs. Consequently, the securing element 4 in the securing receptacle 34 surrounds the contact chambers 22 and the contact units 12 received therein from a correspondingly large number of sides. Depending on the number of contact chambers 22, the securing element 4 can have a U-profile, a double U-profile or a multiple U-profile.

The chock section 56 and/or lock section 52 can be configured so that it can be received in the aforementioned evasive recess 104 and abut against the blocking section 98 in the securing position 36 of the securing element 4 (see FIG. 4). For example, the chock section 56 may preferably protrude from the rest of the securing element 4 in the securing insertion direction 40. The chock section 56 may also serve as the detecting section 106 and abut against the blocking section 98 when the blocking section 98 blocks the securing receptacle 34.

FIG. 6 shows an exploded view of the connection device 20 with the above plug connector 8 and with the mating plug 18 configured complementarily to the plug connector 8. Plug connector 8 and mating plug 18 are configured so that they can be plugged together.

The mating plug 18 can have a connector housing 108 configured complementarily to the contact housing 2 of the plug connector 8. In the connector housing 108, a mating contact 16 of the mating plug 18 can be received in a latching manner for each contact unit 12. In this case, each mating contact 16 is configured complementarily to and can be plugged together with the associated contact unit 12.

The mating plug 18 can also have a securing element 4′, which is configured analogously to the securing element 4 of the plug connector 8. Thus, the connection device 20 can benefit from the functions of the respective securing element 4, 4′ in both the plug connector 8 and the mating plug 18.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Housing assembly for a plug connector comprising:
a securing element including at least one chock section and at least one lock section; and
a contact housing, wherein the contact housing comprises:
at least one contact chamber for receiving a contact unit of the plug connector,
at least one latching element movable between a latching position and a release position, which in the latching position protrudes at least sectionally into the at least one contact chamber, and
a securing receptacle leading at least sectionally into the at least one contact chamber, which securing receptacle is configured to receive the securing element at least partly,
wherein, when the securing element is completely received in the securing receptacle, a movement of the at least one latching element from the latching position in a direction away from the at least one contact chamber is blocked by the at least one chock section and the at least one lock section protrudes at least partly from the securing receptacle into the at least one contact chamber.

2. Housing assembly according to claim 1, wherein the at least one chock section and the at least one lock section are located opposite of each other with respect to the at least one contact chamber when the securing element is completely received in the securing receptacle.

3. Housing assembly according to claim 1, wherein the at least one chock section and the at least one lock section extend at least partly parallel to each other.

4. Housing assembly according to claim 1, wherein the latching element moved out of the latching position forms a stop for the at least one chock section of the securing element.

5. Housing assembly according to claim 4, wherein the stop is located in a region of the securing receptacle in which the at least one chock section is located when the securing element is completely received in the securing receptacle.

6. Housing assembly according to claim 4, wherein the region of the securing receptacle is swept over by the stop during the movement of the at least one latching element from the latching position into the release position.

7. Housing assembly according to claim 1, wherein the at least one latching element comprises a cantilevered latching arm.

8. Housing assembly according to claim 1, wherein the securing receptacle extends at least sectionally transversely to the at least one contact chamber.

9. Housing assembly according to claim 1, wherein the contact housing comprises two contact chambers extending at least sectionally parallel to each other, and wherein the securing receptacle extends at least sectionally between the two contact chambers.

10. Housing assembly according to claim 9, wherein the at least one latching element extends at least sectionally between the two contact chambers.

11. Housing assembly according to claim 9, wherein the at least one chock section or the at least one lock section extends at least sectionally between the two contact chambers when the securing element is completely received in the securing receptacle.

12. Plug connector comprising:
a housing assembly including a securing element and a contact housing, the securing element including at least one chock section and at least one lock section, the contact housing including at least one contact chamber, the contact housing including at least one latching element movable between a latching position and a release position, which in the latching position protrudes at least sectionally into the at least one contact chamber, and the contact housing including a securing receptacle leading at least sectionally into the at least one contact chamber, which securing receptacle is configured to receive the securing element at least partly, wherein, when the securing element is completely received in the securing receptacle, a movement of the at least one latching element from the latching position in a direction away from the at least one contact chamber is blocked by the at least one chock section and the at least one lock section protrudes at least partly from the securing receptacle into the at least one contact chamber; and
at least one contact unit for contacting mating contacts of a mating plug, wherein a respective contact unit is received in a respective contact chamber of the contact housing and is in a latching connection with the at least one latching element, and wherein the securing element is completely received in the securing receptacle, secures the latching connection with the at least one chock section and is in form-fit connection with the at least one contact unit via the at least one lock section.

13. Plug connector according to claim 12, wherein the at least one lock section abuts against the contact housing on a side facing away from the form-fit connection.

14. Plug connector according to claim 12, wherein the securing element has at least one support section which abuts against the at least one contact unit, wherein the at least one support section is spaced apart from the at least one latching element and the at least one lock section in an extension direction of the at least one contact chamber.

15. Plug connector according to claim 12, wherein the at least one chock section and the at least one lock section are located opposite of each other with respect to the at least one contact chamber when the securing element is completely received in the securing receptacle.

16. Plug connector according to claim 12, wherein the latching element moved out of the latching position forms a stop for the at least one chock section of the securing element.

17. Plug connector according to claim 12, wherein the at least one latching element comprises a cantilevered latching arm.

18. Plug connector according to claim 12, wherein the securing receptacle extends at least sectionally transversely to the at least one contact chamber.

19. Plug connector according to claim 12, wherein the contact housing comprises two contact chambers extending at least sectionally parallel to each other, and wherein the securing receptacle extends at least sectionally between the two contact chambers, the at least one contact unit includes two contact units received in the corresponding two contact chambers.

20. Connection device comprising:
a plug connector including a housing assembly and at least one contact unit, the housing assembly including a securing element and a contact housing, the securing element including at least one chock section and at least one lock section, the contact housing including at least one contact chamber, the contact housing including at least one latching element movable between a latching position and a release position, which in the latching position protrudes at least sectionally into the at least one contact chamber, and the contact housing including a securing receptacle leading at least sectionally into the at least one contact chamber, which securing receptacle is configured to receive the securing element at least partly, wherein, when the securing element is completely received in the securing receptacle, a movement of the at least one latching element from the latching position in a direction away from the at least one contact chamber is blocked by the at least one chock section and the at least one lock section protrudes at least partly from the securing receptacle into the at least one contact chamber, wherein a respective contact unit is received in a respective contact chamber of the contact housing and is in a latching connection with the at least one latching element, and wherein the securing element is completely received in the securing receptacle, secures the latching connection with the at least one chock section and is in form-fit connection with the at least one contact unit via the at least one lock section; and
a mating plug configured complementarily to the plug connector, the mating plug including mating contacts configured for mating with the at least one contact unit, wherein the plug connector and the mating plug are configured so that they can be plugged together.
